(19) United States
(12) Patent Application Publication
(10) Pub. No.: US 2013/0312312 A1
(43) Pub. Date: Nov. 28, 2013

(54) Animal Trap With Spring-Latched Seals

(71) Applicants: Joseph Coito, Gustine, CA (US); Alix K. Co, Modesto, CA (US)

(72) Inventors: Joseph Coito, Gustine, CA (US); Alix K. Co, Modesto, CA (US)

(21) Appl. No.: 13/886,260

(22) Filed: May 2, 2013

Related U.S. Application Data
(60) Provisional application No. 61/641,470, filed on May 2, 2012.

(51) Int. Cl. A01M 23/18

(52) U.S. Cl. CPC A01M 23/18
USPC 43/61

(57) ABSTRACT

An animal trap is disclosed which includes a latch and spring mechanism to secure the entrance opening seal. This mechanism provides give to avoid deformation and/or the seal becoming disengaged.

### CROSS-REFERENCE TO RELATED APPLICATION

This application claims the benefit of U.S. Provisional Application No. 61/641,470, filed May 2, 2012.

### FIELD OF THE INVENTION

The present invention relates to animal traps, including humane small animal traps with one or more spring-latched entrance opening seals.

### BACKGROUND

Humane or “repeating” traps are well-known, such as the construction described in U.S. Pat. No. 7,866,086 (the '086 patent). Such a trap utilizes a hinged passageway door (112) that is biased to favor a closed position but is configured to allow an incoming animal to readily open and pass through it as the animal enters the trap. The passageway door has a bias that causes it to re-close after an incoming animal passes through it.

This trap includes an entrance opening (111A, 111N) through which the animal passes to arrive at the passageway door (112). The entrance opening includes an entrance opening seal (310A, 310N) that is connected to the trap by a hinge that allows the seal to rotate sideways on one side of the entrance opening (see '086 patent, FIG. 3 and col. 6, lines 30-42). In this manner, the seal may close the entrance opening or be left open. A latching apparatus enables the non-hinged end of the entrance opening seal to be latched into closed position at the other side of the entrance opening, or latched into open position. The latching apparatus can be prone to at least two drawbacks, however.

First, when the trap is transported, it may experience accelerations of movement, or may be placed upside down or oriented at an angle other than right-side-up as the trap would be oriented when in use. These factors may loosen the latching assembly that holds the entrance opening seal in the closed position. In turn, the entrance opening seal may be disengaged and thus allowed to swing about. This may lead to damage so that the seal later does not properly operate. For example, the seal may be bent or otherwise distorted so that it may not be held in a closed position by the latch.

Second, even though the passageway door may be configured so that it is difficult for an animal to reopen the door once inside the trap, this difficulty may be lessened where damage has occurred during transport, i.e., in addition to the seal and/or latch being damaged, the door or other aspects of the trap may be bent or otherwise damaged. This may be especially true when the trap is transported while containing one or more animals. In that case, if the latching assembly has already become disengaged on its own due to those same factors, the animal(s) are free to escape. Even if the latching assembly has not become disengaged, it may be loosened, making it easy for one of the contained animals to disengage it.

Beyond the foregoing, the latching apparatus used to secure the entrance opening seal may bend, break or otherwise fail. For example, such latches may not comprise weather-resistant material.

### SUMMARY OF THE INVENTION

The current invention addresses the foregoing and other drawbacks associated with traps. In a first aspect of the invention, the latch and spring mechanism is used to secure the entrance opening seal. This mechanism preferably provides give to avoid deformation and/or the seal becoming disengaged.

In another aspect of the invention, the latch and spring mechanism may comprise a weather-resistant material so that the mechanism may withstand the environment and avoid the drawbacks noted above.

### BRIEF DESCRIPTION OF THE DRAWINGS

FIG. 1 is a partial perspective view of an animal trap according to an embodiment of the invention, showing the spring-latch seal open and swung away from the opening entrance.

FIG. 2 is another partial perspective view of the animal trap of FIG. 1, showing the spring-latch seal latched shut over the opening entrance.

### DETAILED DESCRIPTION OF AN EMBODIMENT

The disclosure of U.S. Pat. No. 7,866,086 is incorporated by reference as if set forth in full here; for convenience, reference numbering and naming corresponding to that used in the '086 patent is used in the present drawings and description for corresponding parts. However, it should be noted that components described herein are different than components bearing the same reference numerals in the '086 patent.

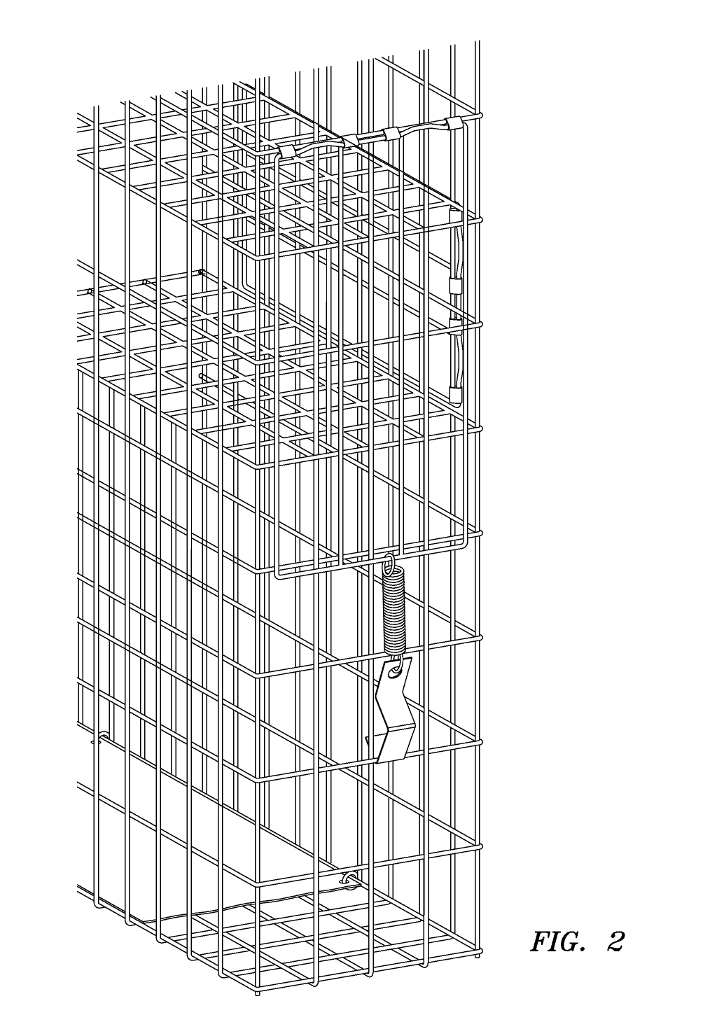

As shown in the drawings, a trap 101 has an entrance opening 111 leading to a passageway 130 (which is gated by a passageway door 112 as show in FIG. 2). An entrance opening seal 310 is pivotally attached to the trap 101 at hinges 311 which are provided at one end of the entrance opening seal 310. A spring latch 600 may be provided at the other end of the entrance opening seal 310 to secure that end of the seal 310 to the trap 101.

The spring latch 600 may comprise a latch 601 having an eyelet 602. A spring 603 may generally connect to the latch 600 and trap 101. More specifically, the spring 603 may include a first ring 604 which connects the sprint 603 to the trap 111. The spring 603 may include another ring 604 at its other end that connects to the eyelet 602 of the latch 601.

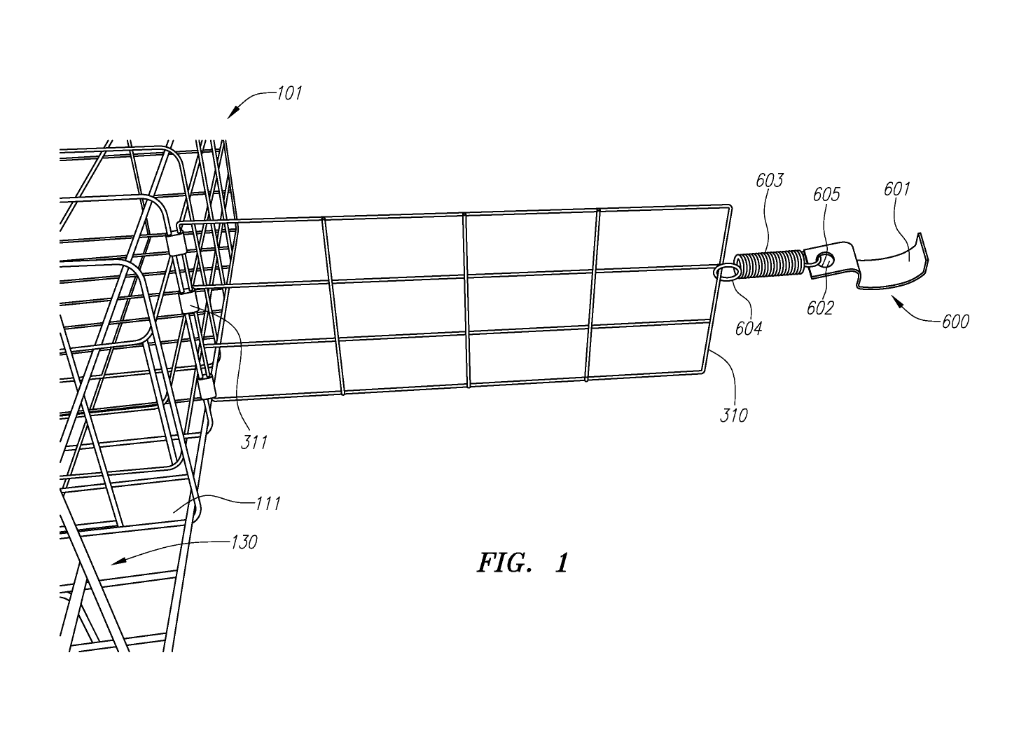

In FIG. 1, the entrance opening seal 310 is open and swung away from the entrance opening 111. In FIG. 2, the entrance opening seal 310 is closed and latched shut over the entrance opening 111, with latch 601 hooked over an aspect of the trap 101 on the side of the entrance opening 111 opposite the hinges 311 such that the spring 603 is in tension. The give provided by the tensioning of the spring 603 in this position allows the trap 101 to undergo accelerations of movement and/or placement into orientations other than the intended trapping orientation—and/or pressure to be applied by a contained animal on the entrance opening seal 310—without the entrance opening seal 310 loosening or becoming disengaged.

This is in sharp contrast to existing latching mechanisms that may rely on a hook attached to the seal, where the hook is intended to engage part of the mesh comprising the trap. In this case, without the benefit of the give provided by a spring, the hook could become easily disengaged thereby allowing the seal to open. Alternatively, the hook could be bent or damaged again allowing the seal to open. The current invention avoids these drawbacks.

The latch 601 preferably is configured so that it similarly can be hooked (not shown) over an aspect of the trap 101 on the same side of the entrance opening 111 as the hinges 311 so as to securely hold the entrance opening seal 310 in an unsealed (open) position, such as when the trap 101 is baited and set.

The spring latch mechanism 600 is preferably made of weather-resistant materials that will reduce or avoid rusting or other degradation. To this end, mechanism 600 may comprise aluminum or other suitable rust resistant material. Alternatively, mechanism 601 may be galvanized or coated with some other suitable coating. Preferably, both latch 601 and spring 603 are weather-resistant.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. An animal trap, comprising:
an entrance opening;
an entrance opening seal which is pivotally attached to the trap at one end of the entrance opening seal; and
a spring latch located at another end of the entrance opening seal to secure that other end to the trap.

2. The animal trap of claim 1, wherein the entrance opening seal is pivotally attached to the trap by hinges.

3. The animal trap of claim 1, wherein the spring latch provides give to avoid deformation and/or the seal becoming disengaged.

4. The animal trap of claim 1, wherein the spring latch includes a spring and a latch.

5. The animal trap of claim 4, wherein the spring is connected to the trap and the latch is connected to the spring.

6. The animal trap of claim 5, wherein the latch is hooked over an aspect of the trap.

7. The animal trap of claim 6, wherein the latch is hooked over an aspect of the trap on the side of the entrance opening opposite the hinges.

8. The animal trap of claim 4 wherein the spring is in tension when the entrance opening seal is closed over the entrance opening.

9. The animal trap of claim 5, wherein the spring is connected to the trap by a ring and the latch is connected to the spring by another ring.
